(19) United States
(12) Patent Application Publication
(10) Pub. No.: US 2011/0018844 A1
(43) Pub. Date: Jan. 27, 2011

(54) METHOD AND SYSTEM FOR INPUTTING DOCUMENT INFORMATION

(75) Inventors: Do-Young Ko, Seoul (KR); Myung-Kyu Kim, Seoul (KR)

Correspondence Address: CANTOR COLBURN LLP, 20 Church Street, 22nd Floor, Hartford, CT, 06103, US

(73) Assignee: PNF CO., LTD., Seoul (KR)

(21) Appl. No.: 12/934,421

(22) PCT Filed: Feb. 23, 2009
(86) PCT No.: PCT/KR09/00857

§ 371 Date: Sep. 24, 2010

(30) Foreign Application Priority Data
Mar. 26, 2008 (KR) 10-2008-0028105

(51) Int. Cl. G06F 3/033

(52) U.S. Cl. 345/179

(57) ABSTRACT

Provided are document information input method and system. When a user writes a document by using an input pen at a working site, a position of the input pen used by the user is measured in real time and position information is transmitted through a wired or wireless communication network to a document information input apparatus. The document information input apparatus can input contents written by the user or figures or characters drawn by the user in a computerization system in real time, so that it is possible to improve work efficiency of document task.

### TECHNICAL FIELD

The present invention relates to a document information input method and system, and more particularly, to document information input method and system where a user at a remote site inputs document information by measuring a position of an input pen used for writing document in real time and transmitting position information through a wireless communication network to a document information input apparatus.

### BACKGROUND ART

Recently, as the development of the IT technology, office works are generally performed by using computers. Before personal computers are not generally used, users manually write documents and store the paper documents. However, recently, documents have been generally produced by using word processor programs in computers, and data having a fixed form have been generally managed by using software such as Excel.

Although the paper work in offices is computerized, the document work in outdoor environment is still manually performed by the user according to the conventional manner. When the user comes back to the office, the user inputs the written contents in the computerization system by using the computer.

For example, in the case where an inspector of an organization inspecting a safety state of a construction site visits the site to inspect the safety state, the inspector carries a form sheet of a check list, on which safety items are printed in advance, and writes evaluation scores on the items or checks the items on the check list by using a pen. After the user comes back to the office, the user input the items in a computerization system.

In addition, in the case of a social-welfare worker who visits needy neighbors and writes reports on their situations, a doctor or a nurse who checks patient's states in real time, the documents that are manually written at the working sites need to be input in the computerization system. Therefore, there is a problem in that work efficiency may deteriorate.

As one of methods solving the problem, a tablet notebook PC may be carried so that the document can be directly input in the computerization system at the working site. However, this method has a problem in that the user always carries the heavy tablet notebook PC. Therefore, this method may be more difficult to practically use than the aforementioned method of inputting the documents written at the working site in the computerization system of the office.

### DISCLOSURE

### Technical Problem

The present invention is to provide a document information input method and system capable of performing document input in a computerization system in real time at the same time when a user performs document task at a working site.

### Technical Solution

According to an aspect of the present invention, there is provided a document information input system including: an input pen; a position measurement module which is disposed on a pad supporting a form sheet and which, when a user performs writing on the form sheet by using the input pen, measures a position of the input pen, generates position information of the input pen, transmits the position information in a wired or wireless manner; and a document information input apparatus which receives the position information and input contents written on the form sheet by the user by using the position information.

In the above aspect, the document information input system may further include a communication unit which is connected to the position measurement module in a wired or wireless manner and which receives the position information from the position measurement module and transmits the position information through a wired or wireless communication network to the document information input apparatus.

In addition, the position measurement module may measure the position of the input pen by sensing a pressure which the input pen exerts on the form sheet.

In addition, the input pen may emit a magnetic force line, and the position measurement module may measure the position of the input pen by using an induced current induced by the magnetic force line emitted from the input pen.

In addition, the input pen may generate a reference signal and an ultrasonic signal in the same time period, and the position measurement module may measure the position of the input pen by using a time difference between a receiving time of the reference signal and a receiving time of the ultrasonic signal.

In addition, the position measurement module may include a reference signal receiving unit and a plurality of ultrasonic signal receiving units which are disposed to be separated from each other by a predetermined distance, and the position measurement module may measure the position of the input pen by using a time difference between a time when the reference signal generated by the input pen is received by the reference signal receiving unit and a time when the ultrasonic signal is received by each of the ultrasonic signal receiving units.

In addition, the position information may include form sheet identification information and a coordinate value of the input pen, and the position information input apparatus may input the item written on the form sheet by the user by determining which position of the form sheet corresponds to the position of the input pen by comparing the coordinate corresponding to the form sheet identification information with the coordinate value and may input a figure or a character written by the user by connecting the trajectory of the coordinate values of the input pen.

According to another aspect of the present invention, there is provided a document information input method including steps of: (a) if a user performs writing on a form sheet by using an input pen, a position measurement module disposed on a pad supporting the form sheet measuring a position of the input pen; (c) the position measurement module transmitting the position information in a wired or wireless manner; and (d) a document information input apparatus receiving the position information and inputting contents written on the form sheet by the user by using the position information.

In the above aspect, the document information input method may further include, between the step (a) and the step (c), a step (b) of a communication unit connected to the position measurement module in a wired or wireless manner receiving the position information from the position measurement module and transmitting the position information through a wired or wireless communication network to the document information input apparatus.

In addition, in the step (a), the position measurement module may measure the position of the input pen by sensing a pressure which the input pen exerts on the form sheet.

In addition, in the step (a), the position measurement module may measure the position of the input pen by using an induced current induced by the magnetic force line emitted from the input pen.

In addition, in the step (a), the input pen may generate a reference signal and an ultrasonic signal in the same time period, and the position measurement module may measure the position of the input pen by using a time difference between a receiving time of the reference signal and a receiving time of the ultrasonic signal.

In addition, in the step (a), the position measurement module may include a reference signal receiving unit and a plurality of ultrasonic signal receiving units which are disposed to be separated from each other by a predetermined distance, and the position measurement module may measure the position of the input pen by using a time difference between a time when the reference signal generated by the input pen is received by the reference signal receiving unit and a time when the ultrasonic signal is received by each of the ultrasonic signal receiving units.

In addition, the position information may include form sheet identification information and a coordinate value of the input pen, and in the step (d), the position information input apparatus may input the item written on the form sheet by the user by determining which position of the form sheet corresponds to the position of the input pen by comparing the coordinate corresponding to the form sheet identification information with the coordinate value and may input a figure or a character written by the user by connecting the trajectory of the coordinate values of the input pen.

### Advantageous Effects

According to the present invention, when a user write a document by using an input pen at a working site, a position of the input pen used by the user is measured in real time and position information is transmitted through a wired or wireless communication network to a document information input apparatus. The document information input apparatus can input contents written by the user or figures or characters drawn by the user in a computerization system in real time, so that it is possible to improve work efficiency of document task.

In addition to the document task in a fixed form, the present invention may be adapted to a general task such as e-mail transmission of contents written on a paper.

### DESCRIPTION OF DRAWINGS

FIG. 1 is a diagram for explaining a whole configuration of a document input system according to an exemplary embodiment of the present invention.

FIG. 2 is a detailed diagram for explaining a configuration of an input pen and a position measurement module according to a first embodiment of the present invention.

FIG. 3 is a flowchart for explaining a document information input method according to the first embodiment of the present invention.

FIG. 4 is a diagram for explaining a document information input method according to an exemplary embodiment of the present invention.

### BEST MODE

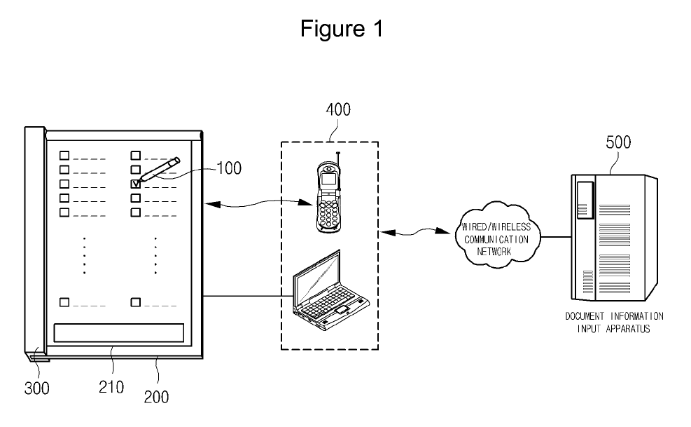

Hereinafter, document information input methods and document information input systems according to exemplary embodiments of the present invention will be described with reference to the attached drawings. FIG. 1 is a diagram for explaining a whole configuration of a document information input system according to an exemplary embodiment of the present invention. Referring to FIG. 1, the document information input system according to the present invention is configured to include an input pen 100, a position measurement module 300, a communication unit 400, and a document information input apparatus 500.

The input pen 100 includes a core portion of which the inner portion is filled with ink so that a user can perform writing on a form sheet on which predetermined items are printed or a general standard paper (hereinafter, referred to as a form sheet 210). As described later, according to an embodiment, the input pen 100 may include a reference signal generator and an ultrasonic signal generator in the inner portion thereof, so that a reference signal and an ultrasonic signal may be generated in the same time period. In addition, the input pen 100 may generate a magnetic force line.

When the user performs writing on the form sheet 210 by using the input pen 100, the position measurement module 300 measures a position of the input pen 100 to generate position information including a coordinate value of the input pen 100 and to transmit the position information to the document information input apparatus 500 by using the communication unit 400 in the wired or wireless manner or to directly transmit the position information to the document information input apparatus 500.

The position measurement module 300 is disposed on a pad 200 supporting the form sheet 210. According to the later-described embodiment, when the user puts the form sheet 210 on the pad 200 and performs writing by using the input pen 100, the position measurement module 300 measures the position of the input pen 100 by sensing a pressure which the input pen 100 exerts on the form sheet 210, measures the position of the input pen 100 by using the magnetic force line generated by the input pen 100, or measures the position of the input pen 100 by using a receiving time difference between the reference signal and the ultrasonic signal generated by the input pen 100.

The communication unit 400 is constructed with a mobile communication terminal, a personal computer, or the like. The communication unit 400 is connected to the position measurement module 300 in a wired or wireless manner, so that the communication unit 400 can transmit the position information received from the position measurement module 300 through a wired or wireless communication network such as a mobile communication network or a wired or wireless internet to the document information input apparatus 500.

The document information input apparatus 500 inputs the information on the item by determining based on the position information of the input pen 100 received from the position measurement module 300 or the communication unit 400 which position or which item corresponds to the position on the predetermined form sheet 210, at which the user performs writing, so that the document information input apparatus 500 can input the document information at the same when the user checks the item on the form sheet 210. In addition, even in the case where the user writes a character or draws a figure on the form sheet 210, the document information input apparatus 500 can input the character or the figure by using the moving trajectory of the input pen 100.

The document information input apparatus 500 stores layout information of the form sheet 210, on which the user is to perform writing, in advance. If the position information is received from the position measurement module 300, the document information input apparatus 500 determines which position on the form sheet 210 corresponds to the coordinate of the input pen 100 included in the position information and inputs that the user performs writing with respect to the item corresponding to the coordinate.

In the case where a character or a figure is to input, if the coordinate of the input pen 110 is in a predetermined area of the form sheet 210 for inputting the character or if the form sheet is a sheet where the writing can be freely performed without predefined items, the figure or the character can be input by using a trajectory connecting the moving coordinate values of the input pen 100 and generating an image from the trajectory. In addition, the characters can be input by performing character recognition on the image of the trajectory.

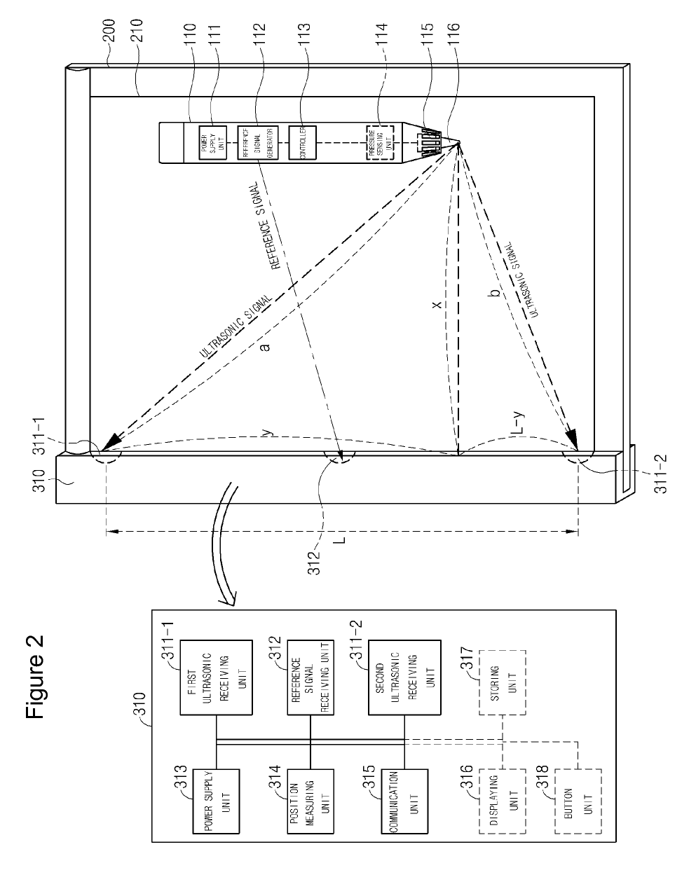

FIG. 2 is a detailed diagram for explaining a configuration of an input pen and a position measurement module according to a first embodiment of the present invention. Referring to FIG. 2, an input pen 100 according to the first embodiment of the present invention is configured to include a reference signal generator 112 which generates a reference signal, an ultrasonic signal generator 115 which generates an ultrasonic signal, a controller 113 which controls the reference signal generator 112 and the ultrasonic signal generator 115 to generate the reference signal and the ultrasonic signal in the same time period (in other words, in the same frequency), and a power supply unit 111 which supplies power to the controller 113, the reference signal generator 112, and the ultrasonic signal generator 115.

If the reference control signal is received from the controller 113, the reference signal generator 112 generates the reference signal which propagates at the speed of light such as an RF signal or an infrared light signal. If the ultrasonic control signal is received from the controller 113, the ultrasonic signal generator 115 generates the ultrasonic signal.

The controller 113 generates the reference control signal to output the reference control signal to the reference signal generator 112 and generates the ultrasonic control signal to output the ultrasonic control signal to the ultrasonic signal generator 115 so that the reference signal and the ultrasonic signal can be generated in the same time period. For example, the controller 113 may generate the reference signal and the ultrasonic signal at the same time, or the controller 113 may generate the reference signal and the ultrasonic signal with a predetermined time difference in the same time period.

On the other hand, a position measurement module 310 is configured to include a plurality of ultrasonic signal receiving units (first ultrasonic signal receiving unit 311-1 and a second ultrasonic signal receiving unit 311-2) which are disposed to be separated from each other by a predetermined distance L, a reference signal receiving unit 312, a position measuring unit 314, a communication unit 315, and a power supply unit 313.

The reference signal receiving unit 312 receives the reference signal generated by the input pen 110 and outputs the reference signal to the position measuring unit 314. The plurality of the ultrasonic signal receiving units 311-1 and 311-2 receive the ultrasonic signal generated by the input pen 110 and output the ultrasonic signal to the position measuring unit 314.

The position measuring unit 314 measures the position (coordinate) of the input pen 110 by using a difference between the time when the reference signal is received by the reference signal receiving unit 312 and the time when the ultrasonic signal is received by each of the ultrasonic signal receiving units 311-1 and 311-2.

In the example illustrated in FIG. 2, with respect to the case where the reference signal and the ultrasonic signal are generated at the same time, a method of measuring the coordinate of the input pen 110 is described. The coordinate (x, y) of the input pen 110 can be obtained by solving the following Equation 1 with respect to x and y.

a²=x²+y²

b²=x²+(L−y)² (Equation 1)

In the Equation 1, since the reference signal, that is, an infrared light or an RF signal propagates at the speed of light, it is assumed that the reference signal is received by reference signal receiving unit 312 at the same time when the reference signal is generated by the input pen 110. The distances a and b can be obtained by multiplying time differences between the time when the reference signal is received and the time when the ultrasonic signal is received by each of the first ultrasonic signal receiving unit 311-1 and the second ultrasonic signal receiving unit 311-2 with the speed of sound. Since the distance L is a predetermined value, the coordinate (x, y) can be obtained by inserting the values of a, b and L into the Equation 1. By using the coordinate values of the moving input pen 110, the contents such as the characters written by the user can be input, and the contents of the predetermined items checked by the user can be input.

On the other hand, in the case where the reference signal and the ultrasonic signal are generated by the input pen 110 with a predetermined time difference in the same time period, the position of the input pen 110 can be measured by using the aforementioned Equation 1 by taking into consideration the time difference. For example, if the reference signal is generated by a time α prior to the ultrasonic signal in the input pen 110, the position of the input pen 110 can be measured by using the time interval from the time when the time α elapses after the reference signal is received to the time when the ultrasonic signal is received by each of the ultrasonic receiving units.

On the other hand, the communication unit 315 of the position measurement module 310 is constructed with a Bluetooth communication module, a USB communication module, or the like to transmit the position information of the input pen 110 to the communication unit 400 in a Bluetooth communication manner or a USB communication manner and transmit the position information through the communication unit 400 to the document information input apparatus 500.

On the other hand, the position measurement module 310 may be configured to directly transmit the position information through a wired or wireless communication network to the document information input apparatus 500.

The power supply unit 111 of the position measurement module 310 supplies powers to the plurality of the ultrasonic signal receiving units 311-1 and 311-2, the reference signal receiving unit 312, the position measuring unit 314, and the communication unit 315.

On the other hand, according to the first embodiment of the present invention, it is preferable that the input pen 110 further includes a button (not shown) which can be pushed by the user at the time of writing or a pressure sensing unit which automatically senses a writing pressure exerted to the core portion 116 of the input pen 110 and outputs the information of the writing pressure to the controller 113 so that the position measurement module 300 can recognizes that the writing is being performed when the user performs the writing by using the input pen 110.

In this case, if a signal is input from the button or the pressure sensing unit 114, the controller 113 generates the reference signal including the information indicating that the writing is being performed. The position measurement module 300 distinguishes the reference signal indicating that the writing is being performed from general reference signals, that is, sync signals. Only in the case where the user performs writing by using the input pen 110, the position measurement module 300 transmits the position information to the document information input apparatus 500.

In addition, according to the first embodiment of the present invention, in the case where various types of form sheets are used without limitation to a predetermined specific form sheet, it is preferable that the position measurement module 300 further includes a storing unit 317 which stores identification information of the form sheet, a displaying unit 316 which displays the identification information to the user, and a button unit 318 through which the user inputs the information of the selected form sheet. In this case, the position measurement module 300 displays the types of form sheets stored in the storing unit 317 on the displaying unit 316. The position measurement module 300 is input with the type of the form sheet which the user selects through the button unit 318.

The position measurement module 300 may allow the identification information of the selected form sheet to be included in the position information and transmit the position information to the document information input apparatus 500.

By using the form sheet identification information included in the position information, the position information input apparatus 500 compares the layout information (coordinate information) of the form sheet, which is stored in advance, with the coordinate value included in the position information so that the contents written by using the input pen 310 can be input.

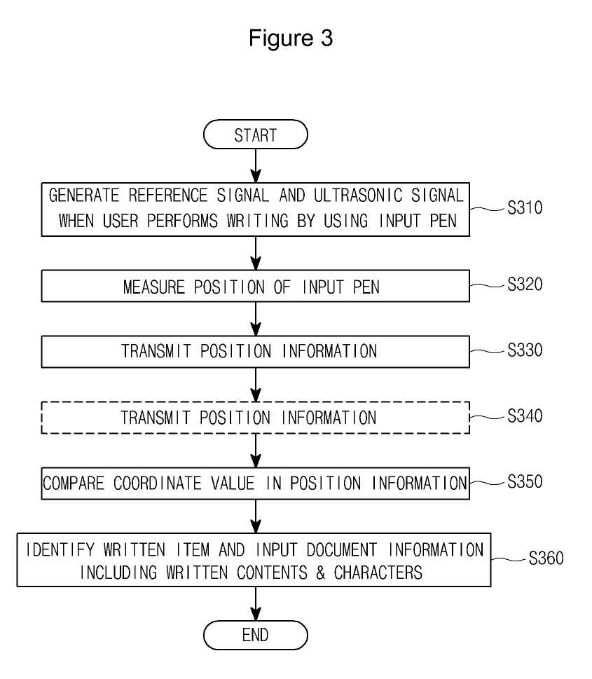

Hereinafter, a document information input method according to the first embodiment of the present invention is described with reference to FIG. 3.

First, the user fixes the form sheet 210, on which predetermined items are printed, on the pad 200. If the user checks the items or writes necessary contents on the form sheet 210 by using the input pen 110, the input pen 110 generates the reference signal and the ultrasonic signal in a predetermined time period during the time when the user performs writing (S310). At this time, in the case where the input pen 110 includes the pressure sensing unit 114 or the writing button, the input pen 110 allows a writing signal indicating that the writing is being performed to be included in the reference signal and transmit the reference signal to the position measurement module 310.

When the reference signal and the ultrasonic signal are received from the input pen 110, the position measurement module 310 generates the position information by measuring the position of the input pen 100 by using the time difference between the time when the reference signal is received by the reference signal receiving unit 312 and the time when the ultrasonic signal is received by each of the ultrasonic signal receiving units 311-1 and 311-2 (S320). In this case, only in the case where the writing signal is included in the reference signal, the position measurement module 310 can generate the position information including the coordinate value of the input pen 110.

In the case where the communication unit 315 of the position measurement module 310 can perform only the local area communication (for example, USB communication, Bluetooth communication, or the like), the position measurement module 310 transmits the position information of the input pen 110 through the communication unit 400 in a wired or wireless manner; and in the case where the communication unit 315 of the position measurement module 310 can perform direct communication through a wired or wireless internet, the position measurement module 310 directly transmits the position information to the document information input apparatus 500 (S330).

In the case where the communication unit 400 receives the position information from the position measurement module 310, the communication unit 400 transmits the received position information through the wired or wireless communication network to the document information input apparatus 500 (S340). However, in the case where the position measurement module 310 can directly transmit the position information to the document information input apparatus 500, Step S340 may be omitted.

When the position information is received from the position measurement module 310 or the communication unit 400, the document information input apparatus 500 compares the coordinate value of the input pen 110 included in the position information with the predetermined coordinate of the form sheet 210 (S350). The document information input apparatus 500 identifies the position on the form sheet, at which the user currently performs writing by using the input pen 110, and inputs the document information including the written contents and characters (S360). In addition, in Step S350, in the case where the form sheet identification information is included in the position information, the position information input apparatus 500 reads the coordinate information corresponding to the form sheet identification information and compares the coordinate value of the input pen 110 with the read coordinate to perform the aforementioned Step S360.

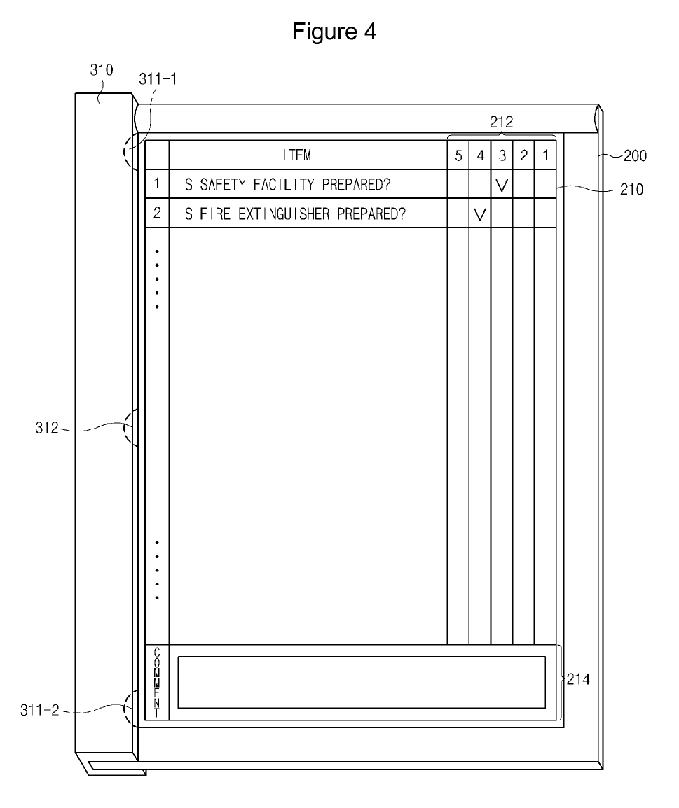

FIG. 4 is a diagram for explaining a document information input method according to an exemplary embodiment of the present invention. As illustrated in FIG. 4, the case where the form sheet 210 on which the user performs inputting is an evaluation sheet where a plurality of questions are provided with answers with five evaluation ratings of excellent (5), good (4), average (3), poor (2), and bad (1) is exemplified. The user fixes the evaluation sheet 210 to the upper left end of the pad 200. After that, when the user makes the mark V on the 4-point score box of the second item in the score area 212 by using the input pen 110, the position information including the coordinate values (for example, (160,50), (162,52), (164,54), (163,53), (161,51), (159,49), or the like) corresponding to the boxes marked by the user is transmitted to the document information input apparatus 500. The document information input apparatus 500 identifies that the item checked by the user is the 4-point score box of the second item by matching the coordinate values in the received position information with the coordinate of the evaluation sheet 210 and inputs the point of 4 as input information of the associated item.

In addition, if the user writes an evaluation comment by shifting the input pen 110 to the area 214 where the evaluation comment is to be written, the document information input apparatus 500 determines that the coordinate value in the position information is currently in the area where the comment is to be written with characters and inputs an image which is generated from the trajectory of the moving coordinate values of the input pen 110. In addition, the characters can be input by performing character recognition on the image.

Hereinbefore, the document information input method and system according to the first embodiment of the present invention are described. The configurations of the document information input methods and systems according to the later-described second and third embodiments are the same as those of the first embodiment except for the configurations of the input pen and the position measurement module and the configuration of the position measuring method. The concepts of the second and third embodiments are described with reference to FIG. 1.

First, the position measurement module 300 according to the second embodiment is constructed with a touch pad which includes a pressure sensor and which is disposed on a surface of the pad 200 supporting the form sheet 210. In the second embodiment, if the user puts the form sheet 210 on the touch pad and performs writing on the form sheet 210 by using the input pen 100, the touch pad senses the pressure which the core portion of the input pen 100 exerts on the form sheet 210, so that the position of the input pen 100 is measured. The coordinate value of the input pen 100 measured by the touch pad is included in the position information. Similarly to the first embodiment, the position information is directly transmitted to the document information input apparatus 500, or transmitted through the communication unit 400 to the document information input apparatus 500.

Since the touch pad including the pressure sensor according to the second embodiment of the present invention is well known in various fields of mobile phones, PDAs, notebook computers, and the like, the detailed description thereof is omitted. In addition, since the document information input method using the position information in the document information input apparatus 500 is the same as that of the aforementioned first embodiment, the detailed description thereof is omitted.

Now, the input pen and the position measurement module according to the third embodiment of the present invention are described. According to the third embodiment, when the user contacts the core portion of the input pen 100 on the form sheet 210 so as to perform writing, the input pen 100 generates a magnetic force line and emits the magnetic force line toward the form sheet 210.

In addition, in the position measurement module 300 according to the third embodiment, a plurality of electrodes are disposed on the surface of the pad 200 supporting the form sheet 210 to be perpendicular to each other. In the position measurement module 300, an induced current is flown according to a change in the magnetic force line generated by the input pen 100, so that the position of the input pen 100 can be measured. Since the input pen 100 and the position measurement module according to the third embodiment are well known in the related art, the detailed description is omitted. In addition, since the document information input method using the position information in the document information input apparatus 500 is the same as that of the aforementioned first embodiment, the detailed description thereof is omitted.

It should be noted that various modified embodiments other than the aforementioned embodiments can be derived within the spirit of the invention. Particularly, in the aforementioned embodiments, the case where the user performs writing on the form sheet 210 by using the input pen including ink is exemplarily described, but the present invention is not limited thereto. In a modified embodiment, a form sheet where the user is to perform writing may be displayed on a touch screen of a tablet notebook PC. When the user performs writing on the form sheet displayed on the touch screen, the tablet PC measures the position, that is, the coordinate at which the user performs the writing. In the same manners as those of the aforementioned embodiments, the tablet PC may transmit the position information directly or through the communication unit 400 to the document information input apparatus 500.

The document information input method invention can also be embodied as computer readable codes on a computer readable recording medium. The computer readable recording medium is any data storage device that can store data which can be thereafter read by a computer system. Examples of the computer readable recording medium include read-only memories (ROMs), random-access memories (RAMs), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims . The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A document information input system comprising:
an input pen;
a position measurement module which is disposed on a pad supporting a form sheet and which, when a user performs writing on the form sheet by using the input pen, measures a position of the input pen, generates position information of the input pen, transmits the position information in a wired or wireless manner; and
a document information input apparatus which receives the position information and input contents written on the form sheet by the user by using the position information.

2. The document information input system according to claim 1, further comprising a communication unit which is connected to the position measurement module in a wired or wireless manner and which receives the position information from the position measurement module and transmits the position information through a wired or wireless communication network to the document information input apparatus.

3. The document information input system according to claim 1, wherein the position measurement module measures the position of the input pen by sensing a pressure which the input pen exerts on the form sheet.

4. The document information input system according to claim 1,
wherein the input pen emits a magnetic force line, and
wherein the position measurement module measures the position of the input pen by using an induced current induced by the magnetic force line emitted from the input pen.

5. The document information input system according to claim 1,
wherein the input pen generates a reference signal and an ultrasonic signal in the same time period, and
wherein the position measurement module measures the position of the input pen by using a time difference between a receiving time of the reference signal and a receiving time of the ultrasonic signal.

6. The document information input system according to claim 5,
wherein the position measurement module includes a reference signal receiving unit and a plurality of ultrasonic signal receiving units which are disposed to be separated from each other by a predetermined distance, and
wherein the position measurement module measures the position of the input pen by using a time difference between a time when the reference signal generated by the input pen is received by the reference signal receiving unit and a time when the ultrasonic signal is received by each of the ultrasonic signal receiving units.

7. The document information input system according to claim 1,
wherein the position information includes form sheet identification information and a coordinate value of the input pen, and
wherein the position information input apparatus inputs the item written on the form sheet by the user by determining which position of the form sheet corresponds to the position of the input pen by comparing the coordinate corresponding to the form sheet identification information with the coordinate value and inputs a figure or a character written by the user by connecting the trajectory of the coordinate values of the input pen.

8. A document information input method comprising steps of:
(a) if a user performs writing on a form sheet by using an input pen, a position measurement module disposed on a pad supporting the form sheet measuring a position of the input pen;
(c) the position measurement module transmitting the position information in a wired or wireless manner; and
(d) a document information input apparatus receiving the position information and inputting contents written on the form sheet by the user by using the position information.

9. The document information input method according to claim 8, further comprising, between the step (a) and the step (c), a step (b) of a communication unit connected to the position measurement module in a wired or wireless manner receiving the position information from the position measurement module and transmitting the position information through a wired or wireless communication network to the document information input apparatus.

10. The document information input method according to claim 8, wherein in the step (a), the position measurement module measures the position of the input pen by sensing a pressure which the input pen exerts on the form sheet.

11. The document information input method according to claim 8, wherein in the step (a), the position measurement module measures the position of the input pen by using an induced current induced by the magnetic force line emitted from the input pen.

12. The document information input method according to claim 8, wherein in the step (a), the input pen generates a reference signal and an ultrasonic signal in the same time period, and the position measurement module measures the position of the input pen by using a time difference between a receiving time of the reference signal and a receiving time of the ultrasonic signal.

13. The document information input method according to claim 12, wherein in the step (a), the position measurement module includes a reference signal receiving unit and a plurality of ultrasonic signal receiving units which are disposed to be separated from each other by a predetermined distance, and the position measurement module measures the position of the input pen by using a time difference between a time when the reference signal generated by the input pen is received by the reference signal receiving unit and a time when the ultrasonic signal is received by each of the ultrasonic signal receiving units.

14. The document information input method according to claim 8,
wherein the position information includes form sheet identification information and a coordinate value of the input pen, and
wherein in the step (d), the position information input apparatus inputs the item written on the form sheet by the user by determining which position of the form sheet corresponds to the position of the input pen by comparing the coordinate corresponding to the form sheet identification information with the coordinate value and inputs a figure or a character written by the user by connecting the trajectory of the coordinate values of the input pen.
